(19) United States
(12) Patent Application Publication
(10) Pub. No.: US 2019/0289463 A1
(43) Pub. Date: Sep. 19, 2019

(54) METHOD AND SYSTEM FOR DUAL-NETWORK AUTHENTICATION OF A COMMUNICATION DEVICE COMMUNICATING WITH A SERVER

(71) Applicant: TELIT COMMUNICATIONS S.P.A., Sgonico (IT)

(72) Inventors: Yann GLOUCHE, Conder-sur-Noireau (FR); Alexis WATINE, Periers sur le Dan (FR)

(73) Assignee: Telit Communications S.p.A., Sgonico (IT)

(21) Appl. No.: 16/317,005

(22) PCT Filed: Jul. 7, 2017
(86) PCT No.: PCT/EP2017/067081

§ 371 Date: Jan. 10, 2019

Related U.S. Application Data
(60) Provisional application No. 62/360,826, filed on Jul. 11, 2016.

(51) Int. Cl. H04W 12/06; H04W 4/14; H04W 8/26; H04W 12/00; H04W 12/04; H04W 8/18; H04W 76/15; H04L 9/32

(52) U.S. Cl. CPC H04W 12/06; H04W 4/14; H04W 8/26; H04L 9/3271; H04W 12/0401; H04W 8/183; H04W 76/15; H04W 12/0017

(57) ABSTRACT

A method of dual-network authentication for a communication device to communicate with a server includes sending a communication request to the server over an Internet Protocol (IP) communication network. In reply to the communication request, a communication challenge is received from the server over a short message service (SMS) communication network. A response is generated to the communication challenge based on one or more unique identifiers of the communication device. The response is sent to the server over the Internet Protocol (IP) communication network. Upon the server authenticating the response, a connection is established with the server over the Internet Protocol (IP) communication network.

### CROSS REFERENCE TO RELATED APPLICATIONS

This application claims the priority of U.S. Ser. No. 62/360,826, filed on Jul. 11, 2016, which is incorporated in its entirety herein by reference.

### FIELD OF THE INVENTION

Embodiments of the present invention relates to communication devices, and particularly to methods and systems for dual-network authentication of a communication device for communicating with a server.

### BACKGROUND OF THE INVENTION

The Internet of Things (IoT) is a network of communication devices often including electronics, sensors, software and network connectivity. IoT communication devices may be deployed, for example, to monitor systems such as automobiles, biological implants, and home appliances. IoT communication devices may gather data about the environment in which they are deployed. The gathered data may then be transmitted over the Internet and relayed to a server. The server may respond by sending commands to control the behavior of the network of IoT communication devices.

IoT networks may require a high level of security to secure both data communicated from the IoT communication device to the server (e.g., a medical monitor transmitting confidential medical information) as well as commands communicated from the server to the communication devices (e.g., instructions to administer drugs to patients, lock or unlock doors in a house or automobile, etc.).

There is a longstanding need in the art to establish secure communication between a server and IoT communication devices in a network.

### SUMMARY OF THE INVENTION

A system and method is provided to overcome the aforementioned longstanding issues inherent in the art for establishing secure communication between a server and IoT communication devices in a network. In accordance with some embodiments of the present invention, a method of dual-network authentication is provided for a communication device to communicate with a server. The method may include sending a communication request to the server over an Internet Protocol (IP) communication network; in reply to the communication request, receiving a communication challenge from the server over a short message service (SMS) communication network; generating a response to the communication challenge based on one or more unique identifiers of the communication device; sending the response to the server over the Internet Protocol (IP) communication network; and upon the server authenticating the response, establishing a connection with the server over the Internet Protocol (IP) communication network.

In accordance with some embodiments of the present invention, the short message service (SMS) communication network may be a cellular network or a satellite telephone network.

In accordance with some embodiments of the present invention, the communication challenge includes a cryptographic challenge.

In accordance with some embodiments of the present invention, the one or more unique identifiers include an International Mobile Equipment Identity (IMEI) and an International Mobile Subscriber Identity (IMSI) number stored in one or more identity modules in the communication device.

In accordance with some embodiments of the present invention, the communication challenge includes a cryptographic random nonce.

In accordance with some embodiments of the present invention, generating the response includes computing a cryptographic hash function based on the cryptographic random nonce, the IMSI number, and the IMEI number.

In accordance with some embodiments of the present invention, the communication challenge is encrypted using a public key uniquely associated with the communication device.

In accordance with some embodiments of the present invention, generating the response includes decrypting the communication challenge using a private key uniquely associated with the communication device.

There is further provided, in accordance with some embodiments of the present invention, a communication device for communicating with a server using dual-network authentication including one or more memor(ies) and one or more processor(s). The processor(s) and/or memor(ies) are configured to store one or more unique identifiers of the communication device. The processor(s) are configured to send a communication request to the server over an Internet Protocol (IP) communication network, in reply to the communication request, to receive a communication challenge from the server over a short message service (SMS) communication network, to generate a response to the communication challenge based on the one or more unique identifiers of the communication device, to send the response to the server over the Internet Protocol (IP) communication network, and upon the server authenticating the response, to establish a connection with the server over the Internet Protocol (IP) communication network.

There is further provided, in accordance with some embodiments of the present invention, a server using dual-network authentication to communicate with a communication device including one or more memories and one or more processors. The one or more processors and/or one or more memories are configured to store a plurality of unique identifiers uniquely identifying a plurality of respective communication devices, and a plurality of public and private keys associated with the plurality of communication devices. The one or more processors are configured to receive a communication request from one of the plurality of communication devices over an internet protocol (IP) communication network, to generate a communication challenge in reply to the communication request, to send the communication challenge to the one of the plurality of communication devices over a short messaging service (SMS) network, to receive a response over the IP communication network from the one of the plurality of communication devices in reply to the communication challenge, and to establish a connection with the one of the plurality of communication devices over the IP communication network upon authenticating the response.

In accordance with some embodiments of the present invention, the one of the plurality of communication devices includes a monitoring device for monitoring a status of a remote appliance, and the monitoring device includes a subscriber identity module (SIM) card and one or more sensors.

In accordance with some embodiments of the present invention, the one or more processors are configured to generate the communication challenge by encrypting a cryptographic random nonce using a public key associated with the one of the plurality of communication devices.

In accordance with some embodiments of the present invention, the plurality of unique identifiers uniquely identifying the one of the plurality of communication devices include an International Mobile Subscriber Identity (IMSI) number and an International Mobile Equipment Identity (IMEI) number, and wherein the one or more processors are configured to authenticate the response by assessing that the response includes a hash function based on the cryptographic random nonce, the IMSI number, and the IMEI number.

There is further provided, in accordance with some embodiments of the present invention, a method for a server using dual-network authentication to communicate with a communication device including in one or more processors and/or one or more memories, storing a plurality of unique identifiers uniquely identifying a plurality of respective communication devices, and a plurality of public and private keys associated with the plurality of communication devices; in one or more processors, receiving a communication request from one of the plurality of communication devices over an internet protocol (IP) communication network; generating a communication challenge in reply to the communication request; sending the communication challenge to the one of the plurality of communication devices over a short messaging service (SMS) network; receiving a response over the IP communication network from the one of the plurality of communication devices in reply to the communication challenge; and establishing a connection with the one of the plurality of communication devices over the IP communication network upon authenticating the response.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates a system of communication devices communicating with a server, in accordance with some embodiments of the present invention;

FIG. 2 schematically illustrates a system for authenticating a communication device to communicate with a server, in accordance with some embodiments of the present invention;

FIG. 3 is a flowchart depicting a method of dual-network authentication for a communication device to communicate with a server, in accordance with some embodiments of the present invention; and

FIG. 4 is a flowchart depicting a method for a server using dual-network authentication to communicate with a communication device, in accordance with some embodiments of the present invention.

The Figures are given as examples only and in no way limit the scope of the invention. It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, us of the conjunction “or” as used herein is to be understood as inclusive (any or all of the stated options).

Communication devices, such as Internet of Things (IoT) communication devices, may be configured with sensors and processors to collect data reporting on the machines or the environments in which they are deployed. The IoT communication devices, or IoT devices, may communicate with other IoT devices or one or more servers over a communication network, such as the Internet. The IoT device communicating with a server may receive access to data such as, for example, HTML content, video, and sound. The IoT device may also use, for example, web services that can return, insert, or modify entries in a database stored in the server.

The server may upload data and change the content of the file system of the IoT communication device. The server may receive the data collected by sensors on the IoT communication device via the communication network and process (e.g., modify) the collected data. The IoT device may connect to a server, which includes database access, web services, and critical information access.

Before each IoT communication device establishes a connection to the server over a communication network, the server authenticates each communication device communicating with the server, which may be important for secure access data control and the data integrity of the server. An insecure IoT communication device communicating with the server, or an insecure server communicating with the IoT device, may be a major vulnerability for the IoT network, which may communicate sensitive data. A security breach at one device node or connection in the IoT network may propagate to other devices throughout the IoT network, regardless of the security implemented at the other nodes or connections. A remote server may authenticate a communication device over the communication network for example by using digital certificates, digital signatures, security tokens, biometric information, and/or digital identity data. The use of digital certificates for authenticating each of the communication devices communicating with a server over the communication network typically requires the server to manage a large database of individual digital certificates for each of the communication devices.

IoT communication devices may include a subscriber identity module (SIM) card for communicating with a server over a cellular or a satellite communication network. The SIM card may include a unique identifier such as an International Mobile Subscriber Identity (IMSI) number, which is a sequence of bits divided into three groups: a mobile country code (MCC) typically three decimal digits, a Mobile Network code (MNC) typically two or three decimal digits and a Mobile Station Identification Number (MSIN) typically nine to ten decimal digits depending on the MNC. The IMSI number is typically used to uniquely identify a subscriber on a mobile network. A server may use General Packet Radio Service (GPRS) connections using SIM cards to access IoT communication devices by using an SMS exchange and/or by using data exchange over the internet (e.g., TCP/IP communications).

Communication devices may also include unique identifiers such as an International Mobile Equipment Identification (IMEI) number to identify the equipment communicating on the cellular or satellite network. For example, a mobile phone may include an IMEI number to identify the mobile phone while communicating on the communication network. The IMEI number is a unique identifier to identify some satellite phones and 3^{rd} Generation Partnership Project (3GPP) mobile phones, such as Global System for Mobile Communication (GSM), Universal Mobile Telecommunication System (UMTS), and Long Term Evolution (LTE) mobile phones. In some embodiments, the IMEI number is used to uniquely identify IoT communication device as described herein.

In some embodiments of the present invention, a server may authenticate a communication device with a SIM card using the IMSI number to establish a connection with the server using dual-network authentication. Dual-network authentication may refer to sending and/or receiving authentication transmissions over two or more communication channels or networks, such as SMS and TCP/IP.

The association between the IMSI number on a SIM card and the IMEI number of the IoT device typically cannot be changed after registration because the association is managed by the telephony operator and stored in its secure server. Moreover, typically only the server stores these associations. If a hacker tries to access the server using a stolen SIM card in a rogue IoT device with an IMEI number that is different than the associated IMEI number stored in the server, the server will identify that the IMEI number has changed during authentication.

In order to verify the IoT device, when the IoT device requests to establish a connection with a server over a network such as the Internet, the server in response may send a challenge in an SMS message to the IoT device over a telephony network, instead of over the Internet, for example. In this manner, the server may verify that it is securely sending the authentication challenge to the correct communication device by using the unique identifier of the IoT device's SIM card (e.g., the telephone number associated with the SIM card). In response, the IoT device to be authenticated can automatically respond to the SMS challenge using another network such as the TCP/IP network, for cross or dual-channel authentication.

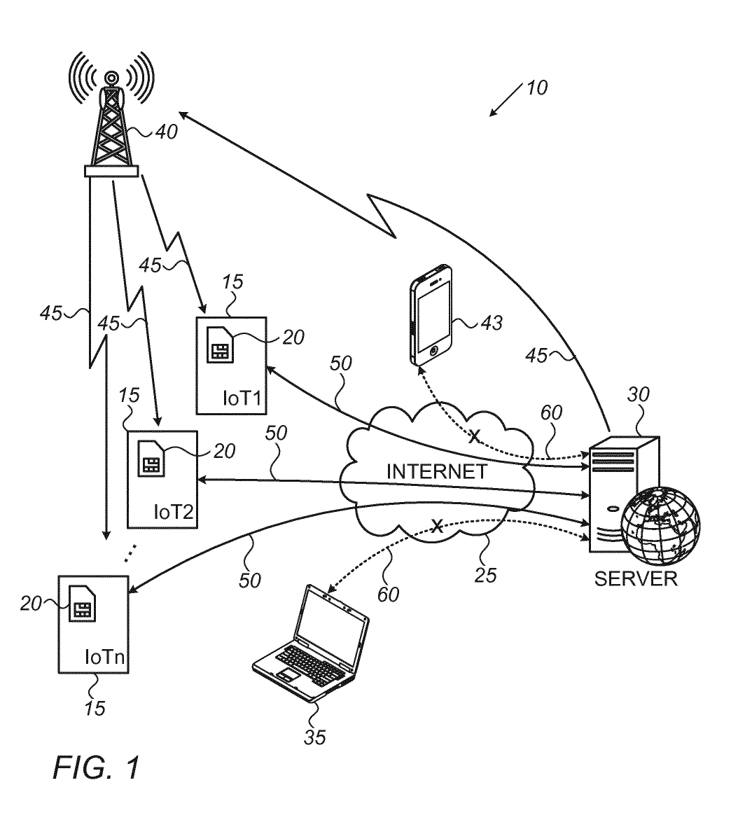

FIG. 1 schematically illustrates a system 10 of communication devices 15 communicating with a server 30, in accordance with some embodiments of the present invention. A number n of IoT communication devices 15 (e.g., IoT device number 1 (IoT1), IoT device number 2 (IoT2), . . . IoT device number n (IoTn), where n is an integer) communicate over authenticated, or allowed, connections 50 with server 30 via the Internet 25. IoT devices 15 may include a SIM card 20 with a unique identifier, such as an IMSI number. Each of IoT devices 15 may also include a unique identifier, such as an IMEI number. A cellphone 43 and/or a laptop 35 may attempt to connect to server 30 over Internet 25 via a connection 60. However, server 30 may refuse connection 60 for both laptop 35 and cellphone 43 as indicated by an X on connection 60 in FIG. 1, since they are not authenticated using the dual-network authentication described herein.

Server 30 may also communicate with IoT devices 15 over a cellular network 45 via a cellular base station 40. IoT devices 15 may communicate over the cellular network 45 and may be registered in the cellular network with the IMSI numbers on SIM cards 20.

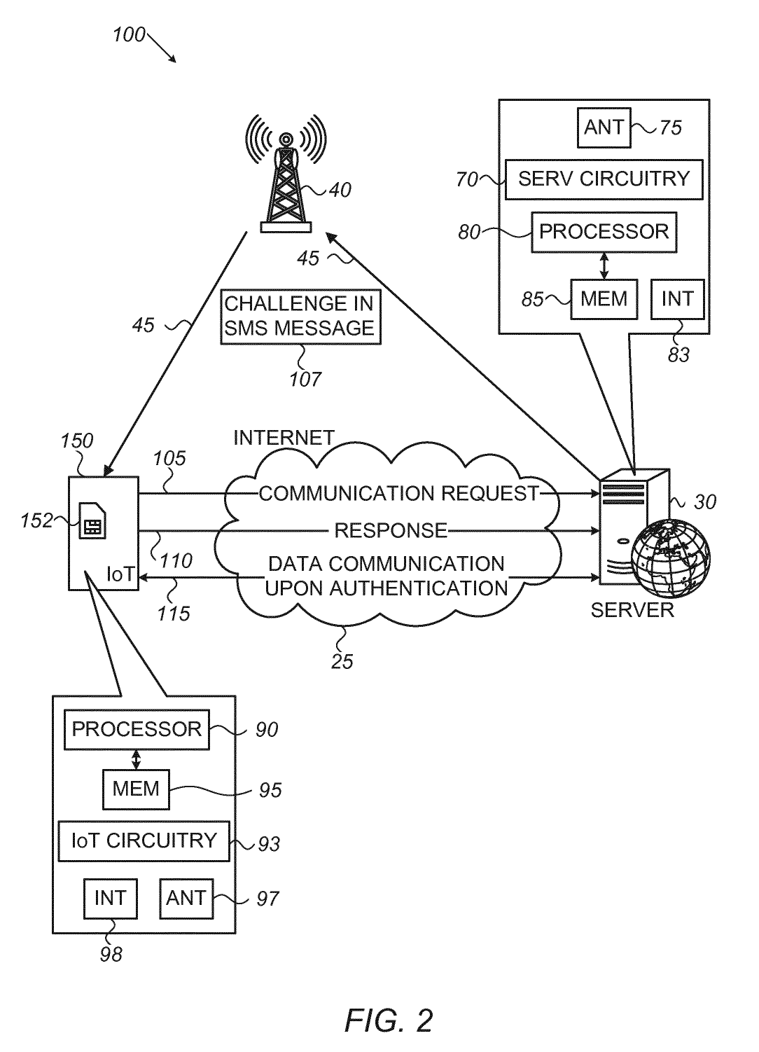

FIG. 2 schematically illustrates a system 100 for authenticating a communication device 150 (e.g., one of IoT devices 15 shown in FIG. 1) to communicate with server 30, in accordance with some embodiments of the present invention. Server 30 may include a processor 80, a memory 85, server circuitry 70 and an antenna 75. Server 30 may include a network interface 83 for communicating over Internet 25. Server circuitry 70 may include, for example, a modem and/or transceiver circuitry for transmitting and receiving signals over cellular communication network 45 via antenna 75, and over Internet 25.

Server 30 may communicate with IoT device 150 over a first communication network, such as cellular communication network 45 via cellular base station 40. Server 30 may also communicate with IoT device 150 via over a second communication network, such as Internet 25. Both server 30 and IoT device 150 (e.g., one of IoT devices 15 from FIG. 1) are configured to communicate over both the first and second communication networks so as to perform dual-network authentication for IoT device 150 to establish secure communication with server 30 as described herein.

IoT device 150 (e.g., one of IoT devices 15 shown in FIG. 1) may include a SIM card 152, an IoT processor 90, an IoT memory 95, IoT circuitry 93, an antenna 97 and a network interface 98 for communicating over Internet 20. IoT circuitry 93 may include, for example, a modem and transceiver circuitry for transmitting and receiving signals over both cellular communication network 45 via antenna 97 and Internet 25 via network interface 98. IoT device 150 may be registered on cellular communication network 45 with unique identifiers stored on SIM card 152, such as the telephone number and the IMSI number. IoT device 150 may also include an additional unique identifier such as an IMEI number identifying the IoT communication device, for example, stored in memory 95.

In some embodiments of the present invention, a method of dual-network authentication is used in order to allow IoT device 150 to establish a connection for communicating with server 30 as follows: IoT device 150 may send a communication request 105 over an internet protocol (IP) network (e.g., internet 25). Server 30 may receive the communication request 105. In reply to the request, the server processor 80 may generate a communication challenge 107. Server 30 may send an SMS message including communication challenge 107 to IoT device 150 over a short message service (SMS) communication network, such as over cellular communication network 45 via cellular base station 40, which supports SMS messaging. For the purpose of authenticating IoT device 150, server 30 may verify that the SMS message is sent only to IoT device 15 over cellular communication network 45 by using the telephone number and/or IMSI number stored on SIM card 152, because only IoT device 15 is identified on network 45 by the unique IMSI number associated with SIM card 152.

IoT device 150 may generate a response 110 to communication challenge 107. Response 110 may be sent to server 30 over an Internet Protocol (IP) communication network (e.g., Internet 25). Upon processor 80 in server 30 authenticating response 110, IoT device 150 may establish a data connection 115 with server 30 over the Internet Protocol (IP) communication network (e.g., Internet 25). Transmissions 105, 107, 110 and 115 may be sent or received sequentially.

In the example of FIG. 2, server 30 includes a processor 80. Processor 80 may include one or more processing units, e.g. of one or more computers. Processor 80 may be configured to operate in accordance with programmed instructions stored in memory 85. Processor 80 may be capable of executing an application for authenticating communication device 150 using a series of transmissions communicated over a dual network including cellular communication network 45 (e.g. via SMS) and Internet Protocol (IP) communication network 25 (e.g., via TCP/IP).

Processor 80 may communicate with memory 85. Memory 85 may include one or more volatile or nonvolatile memory devices. Memory 85 may be utilized to store, for example, programmed instructions for operation of processor 80, data or parameters for use by processor 80 during operation, or results of operations of processor 80.

Similarly, IoT communication device 150 includes a processor 90. Processor 90 may include one or more processing units. Processor 90 may be configured to operate in accordance with programmed instructions stored in memory 95.

Processor 90 may communicate with memory 95. Memory 95 may include one or more volatile or nonvolatile memory devices. Memory 95 may be utilized to store, for example, programmed instructions for operation of processor 90, data or parameters for use by processor 90 during operation, or results of operations of processor 90.

In some embodiments of the present invention, the communication device (e.g., IoT device 150) may include a monitoring device for monitoring a status of a remote appliance. The monitoring device may include SIM card 152 and one or more sensors. A remote appliance as used herein may include any machine and/or environment in the IoT devices are deployed and is not limited to home appliances.

The term dual-network authentication described herein may refer to challenge-response authentication where the challenge is sent by the server over a first communication network and the response is sent by the communication device over a second different communication network. The data connection may be established with the server over the first and/or second communication network upon the server authenticating the response. The first and second communication networks may use different protocols, network infrastructure, base stations, beacons, etc.

Dual-network authentication may improve network security (e.g., in sensitive networks such as IoT networks) by using two (or more) different protocol layers to, cumulatively and only in conjunction (e.g., in a challenge-response communication that builds a combined multi-protocol authentication string), authenticate a device. Accordingly, the system may be impervious to any single-protocol layer security breaches. Due to the difficulty of breaching multiple protocol layers and devices in tandem, this dual-network authentication significantly improves the security of the system beyond standard security improvements to the individual protocol layers (e.g., greater than the sum of its parts).

Dual-network authentication may also improve the speed and efficiency of network authentication by dividing authentication messages (e.g., challenge-response communications) between two (or more) networks. Accordingly, each individual network reduces its authentication communication burden by about half.

In some embodiments, the first communication network is a cellular communication network 45 and the second communication network is an IP communication network such as the Internet (although these networks can be switched between first and second, or other networks can be used). In some embodiments additional third or more networks may be used to communicate additional challenge-response transmissions. Additional networks may be used for additional challenge-response authentication steps for example for all server-device connections or for a subset of connections, for example, where the dual-network authentication fails, if the device response is received after a predetermined threshold time delay from when the challenge is sent, if the IoT device is roaming, if the devices or data are highly sensitive or secure, or other criteria.

In some embodiments, the first communication network is a short message service (SMS) network, such as a cellular network or a satellite telephone network supporting SMS messaging. When SMS message includes the challenge as previously described, the server may verify that the challenge is sent to the correct communication device and is not a rogue device by use of the telephone number and/or IMSI number stored (e.g., unique identifiers) on the SIM card of the communication device when the server uses dual-network authentication.

The server may include a database storing the IMSI of a specific SIM card and the IMEI number of the IoT device in which the specific SIM card is deployed. In some embodiments, the IoT response to the challenge may include the unique IMSI number of the specific SIM card, the IMEI number of the IoT device, and other secure information in the challenge. When the server receives the response, the server may verify that the response is from the correct IoT device and not from a rogue IoT device. Thus, it is harder for a hacker to attempt to establish rogue network connections between the IoT device and the server. While dual-network authentication is typically more secure than, it may be slower than, authenticating IoT devices using a single communication network.

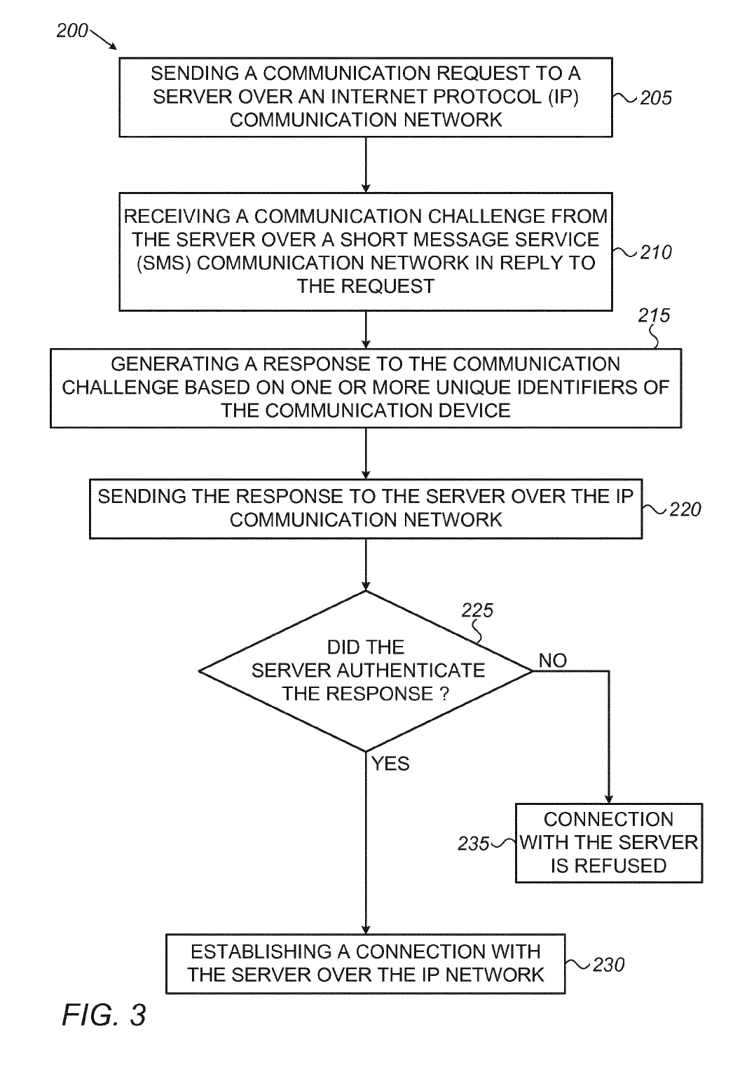

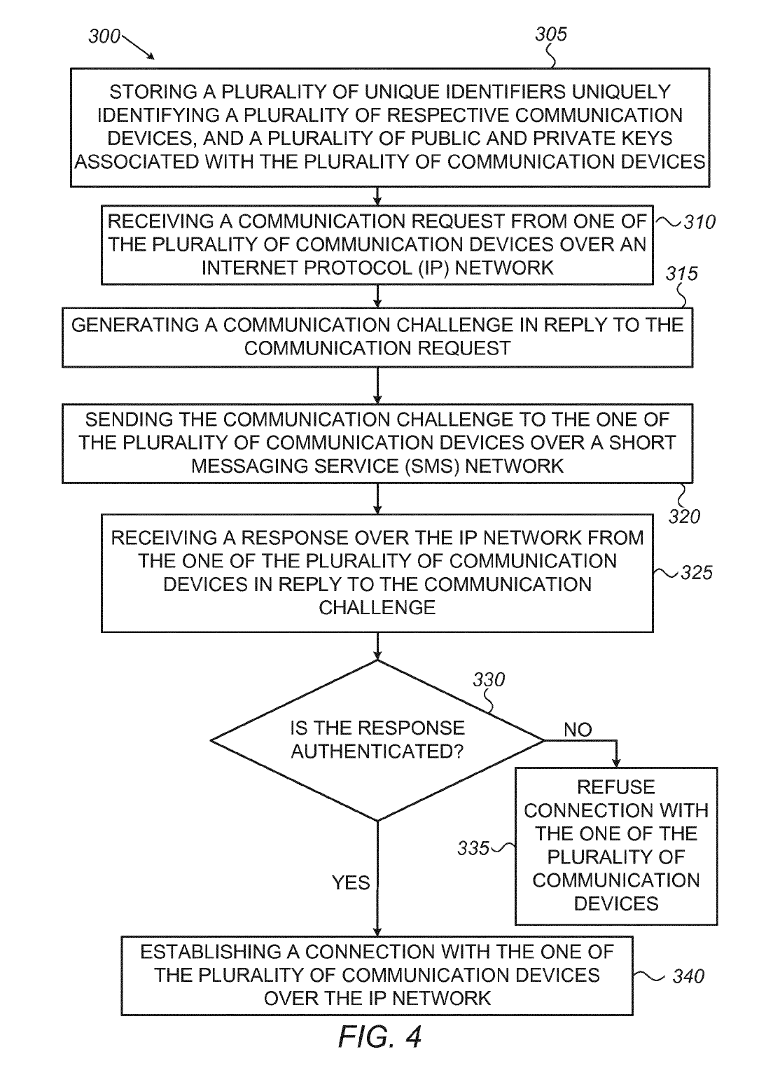

The following figures are flowcharts depicting a method of dual-network authentication of a communication device 150 to communicate with a server 30 in accordance with various embodiments of the invention. The flowchart of FIG. 3 describes the steps that the communication device performs to permit the server to authenticate and establish a data connection with the communication device. The flowchart of FIG. 4 describes the steps that the server performs in authenticating multiple communication devices to permit a data connection with the server.

FIG. 3 is a flowchart depicting a method 200 of dual-network authentication for communication device 150 to communicate with server 30, in accordance with some embodiments of the present invention. Method 200 may be performed by one or more processors, such as, processor 90.

In operation 205, IoT device 150 may send communication request 105 to server 30 over an Internet Protocol (IP) communication network (e.g., Internet 25). In some embodiments, the request may be sent over a secure HTTPS link.

In operation 210, IoT device 150 may receive communication challenge 107 from server 30 over a short message service (SMS) communication network in reply to request 105. In some embodiments, an SMS message including communication challenge 107 may be sent over cellular network 45 via cellular base station 40. In other embodiments, communication challenge 107 may be sent over a satellite telephone network.

In operation 215, IoT device 150 may generate response 110 to communication challenge 107 based on one or more unique identifiers of the communication device (e.g., IoT device 150). The one or more unique identifiers may include the IMEI number of IoT device 150 and the IMSI number stored on an identity module. The identity module may include SIM card 152, for example. Response 110 may include a hash function of the one or more unique identifiers as described herein.

In operation 215, IoT device 150 may send response 110 to server 30 over the IP communication network (e.g., Internet 25).

In a decision operation 225, processor 80 in server 30 may assess if response 110 is authentic. If server 30 authenticates response 110, method 200 may proceed to operation 230; otherwise method 200 may proceed to operation 235.

In operation 230, IoT device 150 may establish data connection 115 with server 30 over the IP network, such as Internet 25.

In operation 230, if server 30 did not authenticate the response, server 30 may refuse data communication 115 connection with IoT device 150 in operation 235.

FIG. 4 is a flowchart depicting a method 300 for server 30 using dual-network authentication to communicate with communication device 150, in accordance with some embodiments of the present invention. Method 300 may be performed by one or more processors (such as server processor 80 in FIG. 2). Method 300 may be performed using one or more memories (such as server memory 85 in FIG. 2).

In operation 305, server 30 may store a plurality of unique identifiers uniquely identifying a plurality of respective communication devices (e.g., IoT devices 15 as shown in FIG. 1), and a plurality of public and private keys associated with the plurality of communication devices 15.

In operation 310, server 30 may receive communication request 105 from one of the plurality of communication devices 15 over an Internet protocol (IP) communication network (e.g., Internet 25).

In operation 315, server 30 may generate communication challenge 107 in reply to communication request 105. Server 30 may use secure information in communication request 105 to generate communication challenge 107.

In operation 320, server 30 may send communication challenge 107 to the one of the plurality of communication devices (e.g., IoT device 150) over a short messaging service (SMS) network such as cellular communication network 45.

In operation 325, server 30 may receive response 110 over the IP communication network from the one of the plurality of communication devices in reply to communication challenge 107.

In a decision step 330, server 30 may assess if response 110 is authentic. If server 30 authenticates response 110, method 300 may proceed to operation 340; otherwise method 300 may proceed to operation 335.

In operation 340, server 30 may establish data connection 115 with the one of the plurality of communication devices (e.g., IoT device 150) over the IP network (Internet 25).

In operation 335, if server 30 did not authenticate the response, server 30 may refuse data communication 115 connection with the one of the plurality of communication devices. In some embodiments, server 30 may send an error message to report the failed authentication to the one of the plurality of communication devices, a network administrator, or a designated system device. In some embodiments, if the communication device that failed authentication attempts to connect to server 30 again, server 30 may use an additional more rigorous authentication regimen such as adding a third or more network layers or requiring multiple authenticated challenge-responses over the dual network.

In some embodiments of the present invention, communication challenge 107 may include a cryptographic challenge. A plurality of private and public keys associated with the plurality of respective communication devices may be stored in the one or more memories such as memory 85 in server 30.

In some embodiments of the present invention, server 30 may encrypt communication challenge 107 with the public key associated with IoT device 150. In other embodiments, processor 90 in IoT device 150 may generate response 110 in operation 215 by decrypting communication challenge 107 received by IoT device 150 using the private key associated with IoT device 150.

In some embodiments of the present invention, in response to communication request 105, processor 80 in server 30 may generate communication challenge 107 by computing for example:

Challenge=Encrypt(randomNonce,publicKey) (1)

where randomNonce includes a random or pseudo-random number also known as a cryptographic nonce to be used only once in authentication protocols. In some embodiments, cryptographic nonces may include a timestamp. In operation 320, server 30 may send communication challenge 107 to IoT device 150 in an SMS message using the telephone number and/or IMSI number stored on SIM card 152. In operation 210, IoT device 150 may receive the SMS message, which includes communication challenge 107.

In some embodiments of the present invention, the security of the protocol may be improved by a challenge with a nonce encryption using a symmetric or an asymmetric key.

In operation 215, IoT device 150 may generate response 110 to communication challenge 107 based on one or more unique identifiers by computing for example:

response=Hash(IMEI+IMSI+Decrypt(challenge,privateKey) (2)

where Hash is a hash function, which includes, for example, the IMEI number associated with IoT device 150, the IMSI number of SIM card 152, and a decryption of the challenge using the private key associated with IoT device 150 where. The Decryption function may be, for example:

Decrypt(challenge,privateKey)=randomNonce (3)

IoT device 150 may send response 110 to server 30 over Internet 25. Processor 80 in server 30 authenticates the response by verifying for example that:

response=Hash(IMEI+IMSI+randomNonce) (4)

In operation 340, if response 110 is authenticated by processor 80, server 30 may establish data connection 115 with IoT device 150. In operation 335, if response 110 is not authenticated by processor 80, server 30 may refuse data connection 115 between server 30 and IoT device 150.

The dual-channel method for authenticating the communication devices for communicating with a server described herein is not limited to SMS and IP communication networks. The embodiments of the present invention may be applied to authenticate any communication devices that communicate over multiple networks, such as, Bluetooth, RF sensor, near field communication (NFC), for example, to authenticate sound modulation devices for communicating with disabled and/or deaf persons, or any other wireless local or wide area public or private networks.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method of dual-network authentication for a communication device to communicate with a server, the method comprising:
sending a communication request to the server over an Internet Protocol (IP) communication network;
in reply to the communication request, receiving a communication challenge from the server over a short message service (SMS) communication network;
generating a response to the communication challenge based on one or more unique identifiers of the communication device;
sending the response to the server over the Internet Protocol (IP) communication network; and
upon the server authenticating the response, establishing a connection with the server over the Internet Protocol (IP) communication network.

2. The method according to claim 1, wherein the short message service (SMS) communication network is selected from the group consisting of: a cellular network and a satellite telephone network.

3. The method according to claim 1, wherein the communication challenge comprises a cryptographic challenge.

4. The method according to claim 1, wherein the one or more unique identifiers include an International Mobile Equipment Identity (IMEI) and an International Mobile Subscriber Identity (IMSI) number stored in one or more identity modules in the communication device.

5. The method according to claim 1, wherein the communication challenge comprises a cryptographic random nonce.

6. The method according to claim 5, wherein generating the response comprises computing a cryptographic hash function based on the cryptographic random nonce, the IMSI number, and the IMEI number.

7. The method according to claim 1, wherein the communication challenge is encrypted using a public key uniquely associated with the communication device.

8. The method according to claim 1, wherein generating the response comprises decrypting the communication challenge using a private key uniquely associated with the communication device.

9. A communication device for communicating with a server using dual-network authentication, the communication device comprising:
one or more memories configured to store one or more unique identifiers of the communication device; and
one or more processors configured to send a communication request to the server over an Internet Protocol (IP) communication network, in reply to the communication request, to receive a communication challenge from the server over a short message service (SMS) communication network, to generate a response to the communication challenge based on the one or more unique identifiers of the communication device, to send the response to the server over the Internet Protocol (IP) communication network, and upon the server authenticating the response, to establish a connection with the server over the Internet Protocol (IP) communication network.

10. The device according to claim 9, wherein the short message service (SMS) communication network is selected from the group consisting of: a cellular network and a satellite telephone network.

11. The device according to claim 9, wherein the communication challenge comprises a cryptographic challenge.

12. The device according to claim 9, wherein the one or more unique identifiers include an International Mobile Equipment Identity (IMEI) and an International Mobile Subscriber Identity (IMSI) number stored in one or more identity modules in the communication device.

13. The device according to claim 9, wherein the cryptographic challenge comprises a cryptographic random nonce.

14. The device according to claim 13, wherein the processor is configured to generate the response by computing a hash function based on the cryptographic random nonce, the IMSI number, and the IMEI number.

15. The device according to claim 9, wherein the communication challenge is encrypted using a public key uniquely associated with the communication device.

16. The device according to claim 9, wherein the one or more processors are configured to compute the cryptographic response by decrypting the communication challenge using a private key uniquely associated with the communication device.

17. A server using dual-network authentication to communicate with a communication device, the server comprising:
one or more memories configured to store a plurality of unique identifiers uniquely identifying a plurality of respective communication devices, and a plurality of public and private keys uniquely associated with the plurality of respective communication devices; and
one or more processors configured to receive a communication request from one of the plurality of communication devices over an internet protocol (IP) communication network, to generate a communication challenge in reply to the communication request, to send the communication challenge to the one of the plurality of communication devices over a short messaging service (SMS) network, to receive a response over the IP communication network from the one of the plurality of communication devices in reply to the communication challenge, and to establish a connection with the one of the plurality of communication devices over the IP communication network upon authenticating the response.

18. The server according to claim 17, wherein the one of the plurality of communication devices comprises a monitoring device for monitoring a status of a remote appliance, and wherein the monitoring device includes a subscriber identity module (SIM) card and one or more sensors.

19. The server according to claim 17, wherein the one or more processors are configured to generate the communication challenge by encrypting a cryptographic random nonce using a public key associated with the one of the plurality of communication devices.

20. The server according to claim 19, wherein the plurality of unique identifiers uniquely identifying the one of the plurality of communication devices comprise an International Mobile Subscriber Identity (IMSI) number and an International Mobile Equipment Identity (IMEI) number, and wherein the one or more processors are configured to authenticate the response by assessing that the response includes a hash function based on the cryptographic random nonce, the IMSI number, and the IMEI number.

21.-25. (canceled)
